(19) United States
(12) Patent Application Publication
(10) Pub. No.: US 2012/0050939 A1
(43) Pub. Date: Mar. 1, 2012

(54) MULTI-LAYERED CERAMIC CAPACITOR

(75) Inventors: Tae Sung SI, Gyunggi-do (KR); Kyung Nam HWANG, Gyunggi-do (KR); Tai Won CHOI, Gyunggi-do (KR)

(73) Assignee: SAMSUNG ELECTRO-MECHANICS CO., LTD, Gyunggi-do (KR)

(21) Appl. No.: 13/014,445

(22) Filed: Jan. 26, 2011

(30) Foreign Application Priority Data
Aug. 24, 2010 (KR) 10-2010-0082119

(51) Int. Cl. H01G 4/005

(52) U.S. Cl. 361/303

(57) ABSTRACT

A multi-layered ceramic capacitor (MLCC) includes: a multi-layered capacitor main body formed by stacking a plurality of dielectric layers and having a size of 0.9 mm in width and 0.6 mm in length; two inner electrodes formed on each of the plurality of dielectric layers, an inner interval therebetween being 70 μm or smaller and an outer interval between the inner electrode and an edge of the dielectric layer being 60 μm or smaller; and a plurality of outer electrodes formed on an outer surface of the capacitor main body and electrically connected to the inner electrodes. An ultra-high capacitor can be implemented and the reliability of the product can be improved by optimizing an inner area of a 0906 size array.

### CROSS-REFERENCE TO RELATED APPLICATIONS

This application claims the priority of Korean Patent Application No. 10-2010-0082119 filed on Aug. 24, 2010, in the Korean Intellectual Property Office, the disclosure of which is incorporated herein by reference.

### BACKGROUND OF THE INVENTION

1. Field of the Invention

The present invention relates to a multi-layered ceramic capacitor and, more particularly, to a multi-layered ceramic capacitor implemented as an ultra-small and high-capacity capacitor by increasing a mounting efficiency thereof by minimizing a mounting area.

2. Description of the Related Art

The present invention relates to a multi-layered capacitor and, more particularly, to a multi-layered capacitor structure capable of reducing an equivalent serial inductance (ESI) suitable for a decoupling capacitor in an RF circuit, and a multi-layered capacitor array using the same.

In general, a multi-layered ceramic capacitor (MLCC) has a structure in which an inner electrode is inserted between a plurality of dielectric layers. The MLCC, having an advantage in that it is small, guarantees a high capacity, and is easily mounted, is widely employed as a component of various electronic devices, and in particular, the MLCC is actively used as a decoupling capacitor connected between a semiconductor chip and a power source in a power circuit such as a large scale integrated (LSI) circuit, or the like,

The MLCC used as a decoupling capacitor is required to have a low equivalent serial inductance (ESI) value in order to restrain a rapid current change and stabilize the power circuit, and the requirement is increasing as the electronic devices recently tend to use a high frequency and a high current.

In general, a method of employing an array structure of inner electrodes has been proposed to lower ESI. For example, in a multi-layered capacitor, adjacent inner electrodes are alternately arranged on first and second dielectric layers, each having a different polarity.

The related art multi-layered capacitor has a structure in which first and second inner electrodes are alternately formed on each of a plurality of dielectric layers. Two or more outer electrodes are provided to the two sides facing the first and second inner electrodes.

The dielectric layers each having the first and second inner electrodes formed thereon are stacked to form a capacitor body, and additionally, external terminals connected to the respective inner electrodes are formed to thus complete the multi-layered chip capacitor.

Here, because the first inner electrode and the second inner electrode are alternately disposed, current directions in the adjacent inner electrodes are the opposite of each other.

Also, recently, in order to meet the demand for smaller components, an array having two or more capacitors, each having the same or different capacitance, implemented in a single chip is required. Also, an array having a plurality of general chips implemented in a single chip is required.

In order to implement high capacity while reducing a mounting area of the chips of such an array, various methods of effectively using the inner area of the array are currently being sought.

### SUMMARY OF THE INVENTION

An aspect of the present invention provides a multi-layered ceramic capacitor (MLCC) having a higher capacity than a prior MLCC while maintaining the same size and thickness thereof.

According to an aspect of the present invention, there is provided a multi-layered ceramic capacitor (MLCC) including: a multi-layered capacitor main body formed by stacking a plurality of dielectric layers and having a size of 0.9 mm in width and 0.6 mm in length; two inner electrodes formed on each of the plurality of dielectric layers, an inner interval therebetween being 70 μm or smaller and an outer interval between the inner electrode and an edge of the dielectric layer being 60 μm or smaller; and a plurality of outer electrodes formed on an outer surface of the capacitor main body and electrically connected to the inner electrodes.

The inner electrode may be formed to have an overlap area with an inner electrode formed on an adjacent dielectric layer, and the overlap area may be 400 μm² or larger.

The capacitor main body may have a width of 0.9±0.15 mm, a length of 0.6±0.10 mm, and a thickness of 0.45±0.10 mm.

The capacitor main body may be formed by stacking a plurality of dielectric layers such that it has a capacity of 2.2 μF.

The capacitor may be manufactured to have a capacity of 2.2 μF with a deviation of ±20%.

The capacitor main body may be formed by stacking a plurality of dielectric layers such that it has a capacity of 2.6 μF.

The capacitor may be manufactured to have a capacity of 2.6 μF with a deviation of ±10%.

According to another aspect of the present invention, there is provided a multi-layered ceramic capacitor (MLCC) including: a multi-layered capacitor main body formed by stacking a plurality of dielectric layers and having a size of 0.9 mm in width and 0.6 mm in length; two inner electrodes formed on each of the plurality of dielectric layers; and a plurality of outer electrodes formed on an outer surface of the capacitor main body and electrically connected to the inner electrodes, wherein the inner electrode are formed to have an overlap area with an inner electrode formed on an adjacent dielectric layer, and the overlap area is 400 μm² or larger.

An inner interval between the two inner electrodes formed on each of the dielectric layers may be 70 μm or smaller and an outer interval between the inner electrode and an edge of the dielectric layer may be 60 μm or smaller.

The capacitor main body may have a width of 0.9±0.15 mm, a length of 0.6±0.10 mm, and a thickness of 0.45±0.10 mm.

The capacitor main body may be formed by stacking a plurality of dielectric layers such that it has a capacity of 2.2 μF.

The capacitor may be manufactured to have a capacity of 2.2 μF with a deviation of ±20%.

The capacitor main body may be formed by stacking a plurality of dielectric layers such that it has a capacity of 2.6 μF.

The capacitor may be manufactured to have a capacity of 2.6 μF with a deviation of ±10%.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view of a multi-layered ceramic capacitor (MLCC) according to an exemplary embodiment of the present invention;

FIG. 2 is a plan view of the multi-layered ceramic capacitor (MLCC) according to an exemplary embodiment of the present invention;

FIG. 3 is a side view of the multi-layered ceramic capacitor (MLCC) according to an exemplary embodiment of the present invention;

FIG. 4 is a plan view of dielectric layers on which first and second inner electrodes are formed according to an exemplary embodiment of the present invention; and

FIG. 5 is an exploded perspective view of the MLCC including a plurality of dielectric layers as stacked according to an exemplary embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

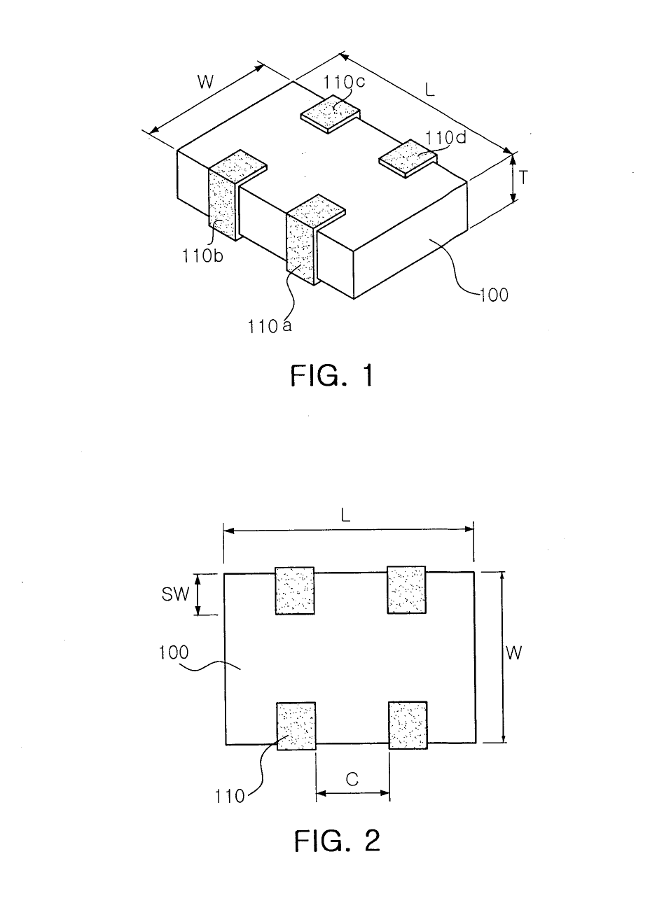

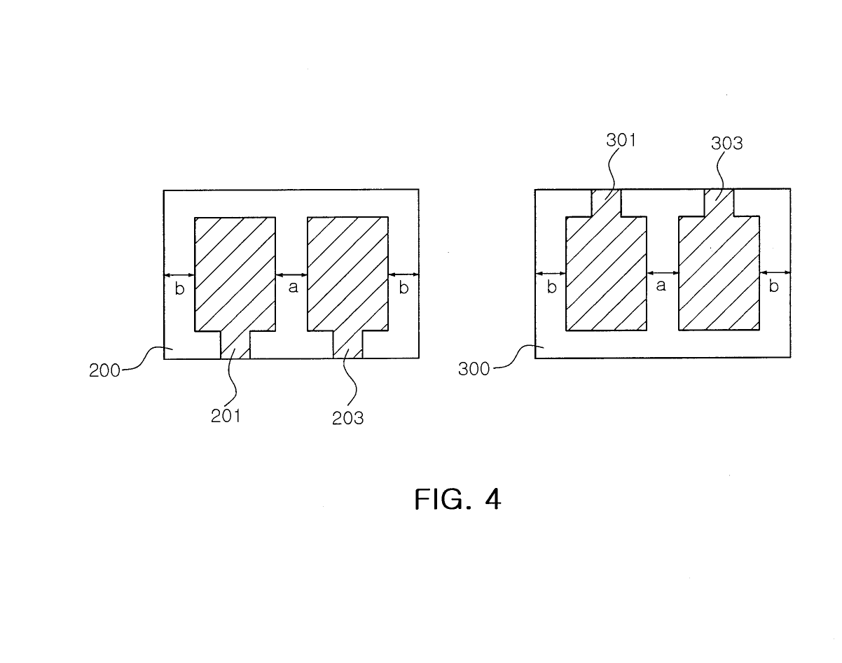

FIG. 1 is a perspective view of a multi-layered ceramic capacitor (MLCC) according to an exemplary embodiment of the present invention. FIG. 4 is a plan view of dielectric layers on which first and second inner electrodes are formed according to an exemplary embodiment of the present invention.

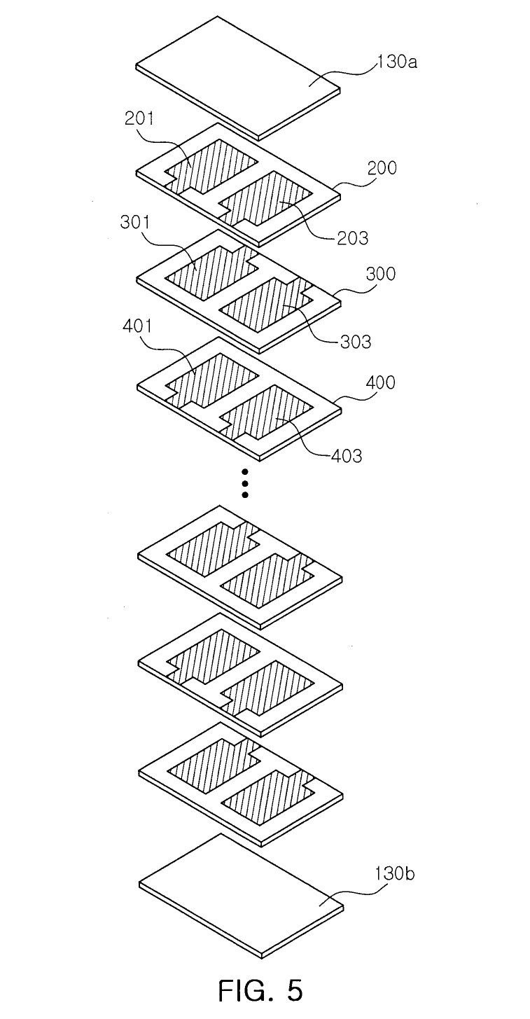

With reference to FIGS. 1 and 5, a multi-layered chip capacitor according to the present exemplary embodiment includes a capacitor main body 100 and a plurality of outer electrodes 110 formed on a surface of the capacitor main body 100.

The capacitor main body 100 may be formed by stacking a plurality of dielectric layers. Each of the dielectric layers of the capacitor main body 100 includes first layer inner electrodes 201 and 203 formed as first and second inner electrodes 201 and 203 and second layer inner electrodes 301 and 303 formed as first and second inner electrodes 301 and 303. The first layer inner electrodes 201 and 203 and the second layer inner electrodes 301 and 303 are alternately disposed such that inner electrodes, each having a different polarity, face each other with the dielectric layer 200, thus forming capacitance.

According to an exemplary embodiment of the present invention, first to fourth outer electrodes 110a, 110b, 110c, and 110d, each having a different polarity, may be positioned at areas corresponding to both sides of the capacitor body 100, and outer electrodes, each having a different polarity, may be arranged to be adjacent on the same side.

With reference to FIG. 1, an x-axis direction of the plane is defined as length (L), a y-axis direction of the plane is defined as width (W), and a z-axis direction based on the plane is defined as thickness (T). The mounted outer electrodes 110 may be positioned on the widthwise plane, but the present invention is not limited thereto.

According to an exemplary embodiment of the present invention, 250 or more dielectric layers are stacked to implement capacity. If the dielectric layer is stacked at less than 250 layers, a desired high capacity cannot be achieved and deviation increases. Thus, 250 or more dielectric layers are stacked to implement a high capacity; however, the present invention is not limited thereto.

Thus, because 250 or more dielectric layers are stacked, a high capacity chip capacitor of 2.2 μF can be formed by using an array having a 0906 size.

In addition, because 250 or more dielectric layers are stacked, the product can be manufactured such that its capacity comes within an M deviation range at 2.2 μF. Namely, the product can be manufactured such that the capacity of the array having the 0906 size has deviation of ±20% at 2.2 μF.

Also, a product can be manufactured to allow the capacity to come within a K deviation range, namely, a ±10% deviation range, while implementing the capacitor having an ultra-high capacitance of 2.6 μF by increasing the number of stacked layers.

According to an exemplary embodiment of the present invention, the capacitor having an ultra-high capacity can be implemented while increasing the reliability of the product by optimizing the size, inner area, and interval of the product.

Thus, according to an exemplary embodiment of the present invention, each of the dielectric layers may have a thickness of 1 μm after being fired, and each of the dielectric layers are mounted according to a reflow method in which solder paste is formed across an electrode.

When the dielectric layers are stacked, the capacitor main body 100 has a length (L) of 0.9 mm with deviation of ±0.15 mm and a width (W) of 0.6 mm with deviation of ±0.10 mm. The multi-layered body has a thickness (T) of 0.45 mm with deviation of 0.10 mm.

Thus, according to an exemplary embodiment of the present invention, 0906 array with the capacitor main body having the length of 0.9 mm and the width of 0.6 mm can be implemented.

With reference to FIG. 2, a vertical length of the outer electrode, when viewed from the plane of the capacitor main body 100, will be defined as an outer electrode length SW, and an interval between outer electrodes formed on one side will be defined as an outer electrode interval (C).

According to an exemplary embodiment of the present invention, the outer electrode length SW may be 0.15 mm with a deviation of ±0.10 mm and the outer electrode interval (C) may be 0.16 mm; however, the present invention is not limited thereto.

The outer electrode length SW and the outer electrode interval (C) have values corresponding to an exemplary embodiment of the present invention and may have various values depending on the shape of the outer electrodes.

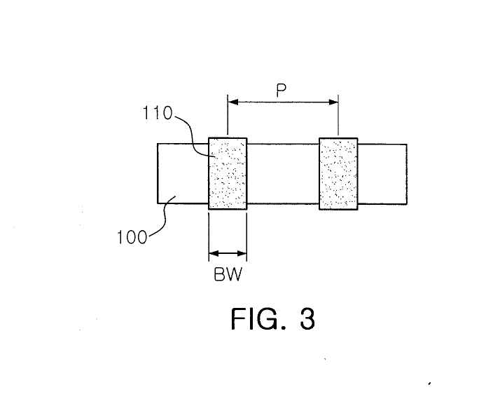

FIG. 3 is a side view of the multi-layered ceramic capacitor (MLCC) according to an exemplary embodiment of the present invention.

The distance between the center of one outer electrode and the center of the other outer electrode when viewed from the side will be defined as an outer electrode central interval (P).

With reference to FIG. 3, according to an exemplary embodiment of the present invention, the outer electrode central interval (P) may be 0.45 mm and may have deviation of ±0.10 mm.

The outer electrode central interval (P) corresponds to an exemplary embodiment of the present invention, and may have various values depending on the structure of the outer electrode.

FIG. 4 is a plan view of dielectric layers on which first and second inner electrodes are formed according to an exemplary embodiment of the present invention.

According to an exemplary embodiment of the present invention, each of the dielectric layers 200 and 300 may have two inner electrodes, respectively. The inner electrodes formed on each of the dielectric layers may be disposed to face the inner electrodes formed on the adjacent dielectric layer.

With reference to FIG. 4, the first layer inner electrodes 201 and 203 including the first and second inner electrodes 201 and 203 are formed on the first dielectric layer 200. The respective inner electrodes have a lead so as to be connected to outer electrodes. In an exemplary embodiment of the present invention, the lead formed at the first inner electrode 201 and the lead formed at the second inner electrode 203 are formed upward so as to be connected to the outer electrodes formed at a lower side.

The second layer inner electrodes 301 and 303 including first and second inner electrodes 301 and 303 are formed on the second dielectric layer 300. The respective inner electrodes have a lead formed upward so as to be connected to the outer electrode formed at an upper side.

With reference to FIG. 5, third layer inner electrodes 401 and 403 including first and second inner electrodes 401 and 403 are formed on a third dielectric layer 400. The respective inner electrodes have a lead formed downward so as to be connected to outer electrodes formed at a lower side.

According to an exemplary embodiment of the present invention, electricity having different polarities is applied to the respective inner electrodes formed on the adjacent dielectric layers. Thus, the inner electrodes formed on the adjacent dielectric layers have different polarities and form capacitance according to the opposed area. As the opposed area is large, the capacitance value increases.

According to a different exemplary embodiment of the present invention, the inner electrodes formed on the dielectric layers are not always formed to be connected to the outer electrodes formed in the same direction but may be electrically connected to the outer electrodes formed at the opposite side.

However, the inner electrodes formed on each of the dielectric layers and the inner electrodes formed on an adjacent dielectric layer are formed to have a different polarity, and as electric fields, each having a different polarity, are formed on the respective inner electrodes, the capacitance is determined according to the overlap area.

With reference to FIG. 5, the leads of the first and second inner electrodes 201 and 203 are formed downward on the first dielectric layer 200, and the first and second inner electrodes 301 and 303 are formed upward on the second dielectric layer 300. Namely, the first layer inner electrodes of the first dielectric layer 200 are electrically connected to the outer electrodes formed at a lower side thereof, and the second layer inner electrodes are electrically connected to the outer electrodes formed at an upper side thereof.

The first layer inner electrodes 201 and 203 and the second layer inner electrodes 301 and 303 formed on the first and second dielectric layers 200 and 300, respectively, are formed to face each other, and the first layer inner electrodes 201 and 203 and the second layer inner electrodes 301 and 303 are formed to have different polarities.

Thus, the first layer inner electrodes 201 and 203 and the second layer inner electrodes 301 and 303 form capacitance, and in an exemplary embodiment of the present invention, as the facing area of the first layer inner electrodes 201 and 203 and the second layer inner electrodes 301 and 303 increases, the capacitance increases.

As a result, the larger the facing area of the inner electrodes formed on the adjacent dielectric layers is, the higher the capacitance that is obtained.

With reference to FIG. 4, the interval between the inner electrodes formed on the respective dielectric layer will be defined as an inner interval (a) of the inner electrodes, and the interval between the respective inner electrodes and the edge of the dielectric layer will be defined as an outer interval (b) of the inner electrodes.

As the inner interval (a) of the inner electrodes and the outer interval (b) of the inner electrodes is reduced, the facing area of the inner electrodes formed on the respective dielectric layers can be increased, and accordingly, the capacitance can be also increased.

With reference to FIG. 4, according to a different exemplary embodiment of the present invention, the inner interval (a) of the inner electrodes formed on the respective dielectric layers is 70 μm or smaller, and the outer electrodes (b) of the inner electrodes is 60 μm or smaller.

Accordingly, when an overlap area of one of the two inner electrodes formed on each of the dielectric layers and the other electrode formed on an adjacent dielectric layer is an overlap area (C), the overlap area (C) may be 400 μm² or larger.

According to an exemplary embodiment of the present invention, the inner overlap area (C) may be maximized, and accordingly, the chip capacitor having a high capacity can be realized.

With reference to FIG. 5, a plurality of dielectric layers 200, 300, and 400 are stacked to form the capacity body.

According to an exemplary embodiment of the present invention, the chip capacitor is formed by stacking the plurality of dielectric layers 200 and 300, and the chip capacitor can have a high capacity by optimizing the overlap area (C) of the inner electrodes formed on the adjacent layers.

In an exemplary embodiment of the present invention, because the array having the 0906 size is implemented, one 0906 sized array having the same capacity as that of two chips can be mounted in a space in which two general chips having a 0603 size (0.6 mm in width and 0.3 mm in length) are mounted.

Thus, because two capacitor chips can be replaced by the one capacitor chip, the manufacturing process of the chip can be simplified, and because the same capacity can be obtained in spite of the large area, a loss rate can be lowered.

In addition, in an exemplary embodiment of the present invention, because the array having the 0906 size can be mounted in a space in which a general chip having a 1005 size (1.0 mm in width and 0.6 mm in length) is mounted, the chip can be reduced in size and integrated.

According to an exemplary embodiment, because the mounting space is optimized by using the 0906 sized array in the place of the 0603 sized general chip or the 1005 sized general chip, a loss rate can be lowered, and because the 2.2 μF ultra-high capacity can be implemented with the 0906 size, the chip can be highly integrated and reduced in size. Thus, it can be used for various purposes, such as a decoupling capacitor.

As set forth above, according to exemplary embodiments of the invention, a small multi-layered ceramic capacitor having a relatively high capacity while maintaining the same size and thickness of a chip can be provided.

While the present invention has been shown and described in connection with the exemplary embodiments, it will be apparent to those skilled in the art that modifications and variations can be made without departing from the spirit and scope of the invention as defined by the appended claims.

What is claimed is:

1. A multi-layered ceramic capacitor (MLCC) comprising:
a multi-layered capacitor main body formed by stacking a plurality of dielectric layers and having a size of 0.9 mm in width and 0.6 mm in length;
two inner electrodes formed on each of the plurality of dielectric layers, an inner interval therebetween being 70 μm or smaller and an outer interval between the inner electrode and an edge of the dielectric layer being 60 μm or smaller; and
a plurality of outer electrodes formed on an outer surface of the capacitor main body and electrically connected to the inner electrodes.

2. The capacitor of claim 1, wherein the inner electrode is formed to have an overlap area with an inner electrode formed on an adjacent dielectric layer, and the overlap area is 400 μm² or larger.

3. The capacitor of claim 1, wherein the capacitor main body has a width of 0.9±0.15 mm, a length of 0.6±0.10 mm, and a thickness of 0.45±0.10 mm.

4. The capacitor of claim 1, wherein the capacitor main body is formed by stacking a plurality of dielectric layers such that it has a capacity of 2.2 μF.

5. The capacitor of claim 4, wherein the capacitor is manufactured to have a capacity of 2.2 μF with a deviation of ±20%.

6. The capacitor of claim 1, wherein the capacitor main body is formed by stacking a plurality of dielectric layers such that it has a capacity of 2.6 μF.

7. The capacitor of claim 6, wherein the capacitor is manufactured to have a capacity of 2.6 μF with a deviation of ±10%.

8. A multi-layered ceramic capacitor (MLCC) comprising:
a multi-layered capacitor main body formed by stacking a plurality of dielectric layers and having a size of 0.9 mm in width and 0.6 mm in length;
two inner electrodes formed on each of the plurality of dielectric layers; and
a plurality of outer electrodes formed on an outer surface of the capacitor main body and electrically connected to the inner electrodes,
wherein the inner electrode are formed to have an overlap area with an inner electrode formed on an adjacent dielectric layer, and the overlap area is 400 μm² or larger.

9. The capacitor of claim 8, wherein an inner interval between the two inner electrodes formed on each of the dielectric layers is 70 μm or smaller and an outer interval between the inner electrode and an edge of the dielectric layer is 60 μm or smaller.

10. The capacitor of claim 8, wherein the capacitor main body has a width of 0.9±0.15 mm, a length of 0.6±0.10 mm, and a thickness of 0.45±0.10 mm.

11. The capacitor of claim 8, wherein the capacitor main body is formed by stacking a plurality of dielectric layers such that it has a capacity of 2.2 μF.

12. The capacitor of claim 11, wherein the capacitor is manufactured to have a capacity of 2.2 μF with a deviation of ±20%.

13. The capacitor of claim 8, wherein the capacitor main body is formed by stacking a plurality of dielectric layers such that it has a capacity of 2.6 μF.

14. The capacitor of claim 13, wherein the capacitor is manufactured to have a capacity of 2.6 μF with a deviation of ±10%.
